(19) United States
(12) Patent Application Publication
(10) Pub. No.: US 2026/0183988 A1
(43) Pub. Date: Jul. 2, 2026

(54) SOFT THERMOPLASTIC ELASTOMER POWDER MATERIAL AND PREPARATION METHOD THEREOF

(71) Applicant: INDUSTRIAL TECHNOLOGY RESEARCH INSTITUTE, Hsinchu (TW)

(72) Inventors: Jin-An WU, Huwei Township (TW); Chen-Yu LIU, Zhubei City (TW); Chin-Lang WU, Tongsiao Township (TW)

(73) Assignee: INDUSTRIAL TECHNOLOGY RESEARCH INSTITUTE, Hsinchu (TW)

(21) Appl. No.: 19/006,564

(22) Filed: Dec. 31, 2024

(51) Int. Cl. B29B 9/12; B29B 9/02; B29K 75/00; C08K 3/22; C08K 3/38; C08K 5/20

(52) U.S. Cl. CPC B29B 9/12; B29B 9/02; C08K 3/22; C08K 3/38; C08K 5/20; B29K 2075/00; C08K 2003/2231; C08K 2003/385; C08K 2201/005

(57) ABSTRACT

A soft thermoplastic elastomer powder has a thermal conductivity coefficient of 0.25 to 0.45 W/mK, a Shore hardness of 20D to 49D, a process window of ≥20° C., and a melt viscosity of less than 1,000 Pa*s (0.63 rad/s) at a specific temperature (Tm+30° C.). The soft thermoplastic elastomer powder includes 100 parts by weight of a thermoplastic polyurethane elastomer, 0.01 to 2.0 parts by weight of a thermal conductive agent, and 0.05 to 2.0 parts by weight of a flow aid agent. The process window of the thermoplastic polyurethane elastomer is ≥15° C. The thermal conductivity coefficient of the thermal conductive agent is 50 to 400 W/mK, and the particle size of the thermal conductive agent is 0.5 μm to 6 μm.

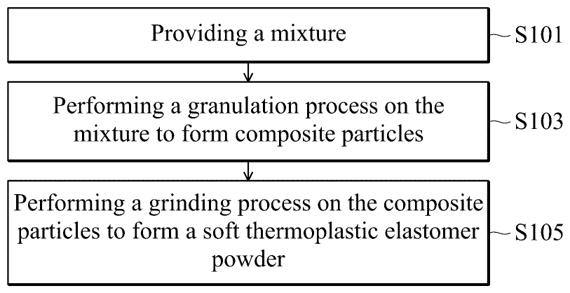

### TECHNICAL FIELD

The present disclosure relates to an elastomer powder and a preparation method thereof, and in particular it relates to a soft thermoplastic elastomer powder and a preparation method thereof.

### BACKGROUND

An additive manufacturing (AM) process is a rapid prototyping manufacturing technology. The additive manufacturing process is a process of printing a desired three-dimensional object by stacking materials layer by layer based on a digital three-dimensional image. Compared to traditional object manufacturing, additive manufacturing does not require molds and is well suited for customized products such as wearables that fit different body shapes, human assistive devices, and medical implants.

Thermoplastic elastomers have such characteristics as high elongation, high elasticity, low compression set, and low brittle temperature at room temperature. They are very popular materials and are used widely in the additive manufacturing process. These thermoplastic elastomers can be recycled and reused, which can reduce the impact of plastic products on the ecological environment. The thermoplastic elastomers can be divided into hard thermoplastic elastomers and soft thermoplastic elastomers. Compared to hard thermoplastic elastomers, soft thermoplastic elastomers are more flexible and more suitable for manufacturing wearable products.

Common soft thermoplastic polymer materials include elastomers such as thermoplastic polyester elastomer (TPEE), thermoplastic polyurethane elastomer (TPU), and thermoplastic polyamide elastomer (TPAE). TPU has been widely used in lightweight shoe midsoles, shoe outsoles, insoles, hot melt adhesives, general shoe uppers and apparel trims, etc. However, TPU is a linear block copolymer composed of a hard segment (crystal phase) structure and a soft segment structure. Because TPU has both a hard segment structure and a soft segment structure, it exhibits complex crystallization and rheology during processing. In addition, a general TPU has a wide melting temperature range during melt processing, but the crystallization rate during cooling is too fast, resulting in a narrow process window. Therefore, the industry is still actively developing TPU materials that are suitable for the additive manufacturing process.

### SUMMARY

The present disclosure discloses a soft thermoplastic elastomer powder material having a larger process window and suitable for selective laser sintering process by using a mixture including a thermoplastic polyurethane elastomer having a specific process window, a thermal conductive agent having a specific thermal conductivity coefficient and a specific particle size, and a flow aid agent.

The present disclosure provides a soft thermoplastic elastomer powder having a thermal conductivity coefficient of 0.25 to 0.45 W/mK, a melt viscosity of less than 1,000 Pa*s (0.63 rad/s) at a specific temperature (Tm+30° C.), a Shore hardness of 20D to 49D, and a process window of >20° C. The soft thermoplastic elastomer powder includes 100 parts by weight of a thermoplastic polyurethane elastomer, 0.01 to 2.0 parts by weight of a thermal conductive agent, and 0.05 to 2.0 parts by weight of a flow aid agent. The process window of the thermoplastic polyurethane elastomer is ≥15° C. The thermal conductivity coefficient of the thermal conductive agent is 50 to 400 W/mK, and the particle size of the thermal conductive agent is 0.5 μm to 6 μm.

The present disclosure provides a preparation method of a soft thermoplastic elastomer powder. The preparation method of the soft thermoplastic elastomer powder includes: providing a mixture, performing a granulation process on the mixture to form composite particles, and performing a grinding process on the composite particles to form the soft thermoplastic elastomer powder. The mixture includes a thermoplastic polyurethane elastomer, a flow aid agent and a thermal conductive agent.

### BRIEF DESCRIPTION OF THE DRAWINGS

The present invention will be more fully understood by reading the following detailed description and examples with reference to the accompanying drawings, wherein:

The drawing is a flow chart of a preparation method of a soft thermoplastic elastomer powder according to an embodiment of the present disclosure.

### DETAILED DESCRIPTION

It will be further understood that the terms “includes” and/or “comprises” when used in this specification, specify the presence of the stated features, integers, steps, operations, elements, components, and/or groups thereof but do not preclude the presence or addition of one or more other features, integers, steps, operations, elements, components, and/or groups thereof. It will also be understood that the singular forms “a” and “an” when used in this specification, they are intended to include the plural forms as well, unless expressly stated otherwise.

It will be understood that the methods described herein include steps, and additional steps may be provided before, during and/or after the steps described. Some of the steps described may be substituted or deleted in different embodiments. Although some embodiments have been discussed as performing the steps in a particular order, the steps may be performed in any other logical order.

The expression “a to b” or “a-b” used herein for a specific range of values is defined as “≥a and ≤b”. The term “process window (Tmₒₙₛₑₜ−Tcₒₙₛₑₜ)” herein refers to a temperature difference between a melting onset temperature (Tmₒₙₛₑₜ) of a material and a crystallization onset temperature (Tcₒₙₛₑₜ) of the material. The term “particle size D₉₀” herein refers to a diameter at which 90% of the cumulative distribution of the material falls. In other words, the term “particle size D₉₀ is c” indicates that the particle sizes of 90% of the materials are smaller than c. The term “melt viscosity” used herein refers to a viscosity of the material at a specific temperature (melting temperature (Tm)+30° C.) and 0.63 rad/s.

One aspect of the present disclosure provides a soft thermoplastic elastomer powder includes 100 parts by weight of a thermoplastic polyurethane elastomer, 0.01 to 2.0 parts by weight of a thermal conductive agent, and 0.05 to 2.0 parts by weight of a flow aid agent. The process window of the thermoplastic polyurethane elastomer is ≥15° C. The thermal conductivity coefficient of the thermal conductive agent is 50 to 400 W/mK, and the particle size of the thermal conductive agent is 0.5 μm to 6 μm. The soft thermoplastic elastomer powder of the present disclosure has a thermal conductivity coefficient of 0.25 to 0.45 W/mK, a Shore hardness of 20D to 49D, a process window of ≥20° C., and a melt viscosity of less than 1,000 Pa*s (0.63 rad/s) at a specific temperature (Tm+30° C.).

The thermoplastic polyurethane elastomer may include a thermoplastic block polyurethane copolymer. In some embodiments, the thermoplastic block polyurethane copolymer may be a block copolymer including hard segments and soft segments. The hard segment may include an isocyanate segment. The soft segment may include a polyether segment, a polyester segment, or a combination thereof. According to the soft segments included in the thermoplastic polyurethane elastomer, the thermoplastic polyurethane elastomer may be classified into polyester-type thermoplastic polyurethane elastomers, polyether-type thermoplastic polyurethane elastomers, or polyether-ester-type thermoplastic polyurethane elastomers. The present disclosure has no specific limitation on the type of thermoplastic polyurethane elastomer, as long as it has a process window of ≥15° C. The composition of the thermoplastic polyurethane elastomer having the above process window, the thermal conductive agent, the flow aid agent and the like may be used to prepare the soft thermoplastic elastomer powder having a process window ≥20° C.

A hardness of the thermoplastic polyurethane elastomer may be adjusted as needed without specific limitation. In some embodiments, a Shore hardness of the thermoplastic polyurethane elastomer may be 20D to 60D, such as 20D to 55D. By adjusting the hardness of the thermoplastic polyurethane elastomer, the soft thermoplastic elastomer powder may have a hardness (20D to 49D Shore hardness), softness, elongation, or elasticity required for the selective laser sintering process. In some embodiments, the soft thermoplastic elastomer powder may be prepared from a thermoplastic polyurethane elastomer having one hardness or may be prepared by mixing two or more thermoplastic polyurethane elastomers having different hardnesses.

In some embodiments, the thermal conductivity coefficient of the thermal conductive agent may be 50 to 400 W/mK. The thermal conductive agent may be selected from the group consisting of aluminum oxide (Alumina, Al₂O₃), boron nitride (BN), aluminum nitride (AlN), graphene, or a combination thereof. The particle size of the thermal conductive agent may be 0.5 μm to 6 μm. In some embodiments, the particle size of the thermal conductive agent may be 0.5 μm to 5 μm. The thermal conductive agent above may improve the thermal conductivity coefficient and/or process window of the soft thermoplastic elastomer powder.

In some embodiments, the flow aid agent may be selected from the group consisting of zinc stearate, N,N-Ethylene bis-stearamide (EBS), vinyltrimethoxysilane, oleamide, or a combination thereof. The particle size of the flow aid agent may be ≤150 μm. In some embodiments, the particle size of the flow aid agent may be 50 μm to 120 μm. The flow aid agent above may improve the thermal conductivity coefficient and/or process window of the soft thermoplastic elastomer powder. In some embodiments, the flow aid agent above may further reduce a melt viscosity of the soft thermoplastic elastomer powder.

The soft thermoplastic elastomer powder disclosed herein may further include up to 3.0 parts by weight of a laser absorber based on 100 parts by weight of the thermoplastic polyurethane elastomer. The laser absorber may be selected from the group consisting of carbon black, silicon carbide (SiC), tin oxide (SnO₂), iron oxide (Fe₂O₃), or a combination thereof. The particle size of the laser absorber may be ≤150 μm. In some embodiments, the particle size of the laser absorber may be 50 μm to 120 μm.

By selecting the thermoplastic polyurethane elastomer, the thermal conductive agent, the flow aid agent, and the laser absorber having the above particle size, the particle size D₉₀ of the soft thermoplastic elastomer powder prepared in the present disclosure may be ≤300 μm. In some embodiments, the particle size D₉₀ of the soft thermoplastic elastomer powder disclosed herein may be less than or equal to 250 μm. In some embodiments, the particle size D₉₀ of the soft thermoplastic elastomer powder disclosed herein may be 50 μm to 300 μm, 50 μm to 250 μm, 100 μm to 250 μm, 100 μm to 130 μm, or 50 μm to 200 μm. The soft thermoplastic elastomer powder having a particle size D₉₀ within the above range may be suitable for a selective laser sintering process.

By selecting the thermoplastic polyurethane elastomer, the thermal conductive agent, the flow aid agent, and the laser absorber having the above characteristics, a melting point of the soft thermoplastic elastomer powder prepared in the present disclosure may be ≤200° C. The soft thermoplastic elastomer powder of the present disclosure may have a thermal conductivity coefficient of 0.25 to 0.45 W/mK. In some embodiments, the thermal conductivity coefficient of the soft thermoplastic elastomer powder prepared in the present disclosure may be 0.25 to 0.40 W/mK or 0.25 to 0.35 W/mK. The soft thermoplastic elastomer powder having the thermal conductivity coefficient within the above range is suitable for a selective laser sintering process and can be sintered and solidified to form a dense and high-precision product.

Furthermore, the soft thermoplastic elastomer powder prepared in the present disclosure may have a melt viscosity of 50 Pa*s to 1,000 Pa*s. In some embodiments, the melt viscosity of the soft thermoplastic elastomer powder prepared in the present disclosure may be ≤700 Pa*s or ≤500 Pa*s. In some embodiments, the melt viscosity of the soft thermoplastic elastomer powder disclosed herein may be 100 Pa*s to 900 Pa*s, 150 Pa*s to 800 Pa*s, 200 Pa*s to 700 Pa*s, 250 Pa*s to 600 Pa*s, or 300 Pa*s to 500 Pa*s. The soft thermoplastic elastomer powder having the melt viscosity within the above range is suitable for a selective laser sintering process and can be sintered and solidified to form a dense and high-precision product.

Another aspect of the present disclosure provides a preparation method of a soft thermoplastic elastomer powder. The drawing is a flow chart of a preparation method of a soft thermoplastic elastomer powder according to an embodiment of the present disclosure. As shown in the drawing, the preparation method of the soft thermoplastic elastomer powder disclosed herein includes: a step S101 of providing a mixture, a step S103 of performing a granulation process on the mixture to form composite particles, and a step S105 of performing a grinding process on the composite particles to form the soft thermoplastic elastomer powder. The mixture provided in step S101 may include a thermoplastic polyurethane elastomer, a flow aid agent, and a thermal conductive agent.

In some embodiments, the mixture may include 100 parts by weight of the thermoplastic polyurethane elastomer, 0.01 to 2.0 parts by weight of the thermal conductive agent, and 0.05 to 2.0 parts by weight of the flow aid agent. In some embodiments, the mixture may further include up to 3.0 parts by weight of a laser absorber. The thermoplastic polyurethane elastomer, the flow aid agent, the thermal conductive agent, and the laser absorber in the mixture may be as described above, so they are not described in detail here.

In some embodiments, the mixture may further include other additive. The particle size of the other additive may be ≤150 μm. In some embodiments, the particle size of the other additive may be 50 μm to 120 μm. Examples of the other additive may include an antioxidant, but the present disclosure is not limited thereto. Examples of the antioxidant may include a hindered phenol antioxidant, a thioester antioxidant, a phosphite antioxidant, or a combination thereof, but the present disclosure is not limited thereto.

The mixture provided in step S101 may be obtained by mixing the thermoplastic polyurethane elastomer, the flow aid agent, the thermal conductive agent, and optional laser absorber and the other additive in a mixing process. In some embodiments, the mixing process may include using a high-speed mixer, but the present disclosure is not limited thereto.

The mixture provided in step S101 may be formed into a plurality of composite particles by a granulation process in step S103. The granulation process may include the use of a single screw extruder or a twin-screw extruder. Specifically, in some embodiments, step S103 may include feeding the mixture provided in step S101 into a twin-screw extruder (25 ¢, L/D=48) for melt extrusion granulation to form composite particles. In some embodiments, the granulation process may include using a screw speed of 150 rpm to 400 rpm and a screw temperature of 170° C. to 200° C. for a mixing time, but the disclosure is not limited thereto.

The composite particles obtained in step S103 may be subjected to a grinding process in step S105 to form a soft thermoplastic elastomer powder. In some embodiments, step S105 may include placing the composite particles obtained in step S103 in liquid nitrogen for freeze-grinding the composite particles into a soft thermoplastic elastomer powder having a particle size D_{90<200} μm. In some embodiments, the composite particles obtained in step S103 may be cryogenically ground into a soft thermoplastic elastomer powder having a particle size D₉₀ of 50 μm to 120 μm in step S105.

The soft thermoplastic elastomer powder obtained in step S105 may have a Shore hardness of 20D to 49D, a melting point of ≤200° C., a thermal conductivity coefficient of 0.25 to 0.45 W/mK, a melt viscosity of 50 Pa*s to 1,000 Pa*s, and a process window of >20° C. In summary, the soft thermoplastic elastomer powder prepared by the preparation method of the soft thermoplastic elastomer powder disclosed in the present disclosure can be applied to a selective laser sintering process and can be used to produce products having a higher tensile strength and/or a higher elongation. In some embodiments, in order to improve the flowability of the soft thermoplastic elastomer powder, a nano-silicon dioxide may be added during drying the soft thermoplastic elastomer powder. The obtained soft thermoplastic elastomer powder can be used in a selective laser sintering process.

In order to make the above contents and other purposes, features, and advantages of the present disclosure more clearly understood, preferred embodiments are specifically cited below and described in detail with reference to the accompanying drawings.

Raw materials used in the specific examples are as follows.

The thermoplastic polyurethane elastomer includes TPU-1, TPU-2, TPU-3, TPU-4 and TPU-5. TPU-1, TPU-2, TPU-3, TPU-4 and TPU-5 are fed into a twin-screw extruder (25 ¢, L/D=48) for melt extrusion granulation. A particle size, a hardness, a process window, a thermal conductivity coefficient, a melt viscosity, a tensile strength and an elongation of TPU-1, TPU-2, TPU-3, TPU-4 and TPU-5 were measured and are shown in Table 1.

TABLE 1

| | Thermoplastic polyurethane elastomer | | | | |
|---|---|---|---|---|---|
| | TPU-1 | TPU-2 | TPU-3 | TPU-4 | TPU-5 |
| Powder hardness (Shore D) | 40 | 40 | 20 | 20 | 55 |
| Particle size of the powder (D₉₀, μm) | 145 | 146 | 143 | 149 | 144 |
| Process window (° C.) | 13.2 | 18.0 | 2.5 | 16.1 | 27.0 |
| Thermal conductivity coefficient (W/mK) | 0.20 | 0.20 | 0.21 | 0.21 | 0.21 |
| Melt viscosity (Tm + 30° C., Pa*s) | 2,546 | 2,340 | 1,898 | 4,570 | 1,644 |
| Tensile strength (kg/cm²) | 36 | 60 | 20 | 32 | 123 |
| Elongation (%) | 115 | 242 | 147 | 151 | 285 |

### Flow Aid Agent: N,N-Ethylene Bis-Stearamide (EBS)

Thermal conductive agent 1 (TD-1): boron nitride (BN), particle size D₉₀: 2 μm
Thermal conductive agent 2 (TD-2): boron nitride, particle size D₉₀: 10 μm
Thermal conductive agent 3 (TD-3): boron nitride, particle size D₉₀: 4 μm
Laser absorber: tin oxide (SnO₂)

### Example 1

100 parts by weight of TPU-2, 1.0 parts by weight of EBS, and 0.5 parts by weight of TD-1 were mixed by a high-speed mixer to obtain a mixture. The mixture was fed into a twin-screw extruder (25 ¢, L/D=48) for melt extrusion granulation to form composite particles, wherein the screw temperature may be 170° C. to 200° C. and the screw speed may be 150 rpm to 400 rpm. The composite particles were placed in liquid nitrogen and cryogenically ground into a soft thermoplastic elastomer powder D having a particle size D₉₀ of about 145 μm.

### Example 2

Except that 1.5 parts by weight of TD-1 was used, composite particles were formed in substantially the same manner as in Example 1. The composite particles were placed in liquid nitrogen and cryogenically ground into a soft thermoplastic elastomer powder E having a particle size D₉₀ of about 143 μm.

### Example 3

Except that 2.5 parts by weight of EBS was used, composite particles were formed in substantially the same manner as in Example 1. The composite particles were placed in liquid nitrogen and cryogenically ground into a soft thermoplastic elastomer powder F having a particle size D₉₀ of about 144 μm.

### Example 4

Except that 2.5 parts by weight of TD-1 was used, composite particles were formed in substantially the same manner as in Example 1. The composite particles were placed in liquid nitrogen and cryogenically ground into a soft thermoplastic elastomer powder G having a particle size D₉₀ of about 142 μm.

### Example 5

Except that 1.5 parts by weight of TD-2 was used, composite particles were formed in substantially the same manner as in Example 1. The composite particles were placed in liquid nitrogen and cryogenically ground into a soft thermoplastic elastomer powder H having a particle size D₉₀ of about 144 μm.

### Example 6

Except that 2 parts by weight of EBS and 1.5 parts by weight of TD-1 were used, composite particles were formed in substantially the same manner as in Example 1. The composite particles were placed in liquid nitrogen and cryogenically ground into a soft thermoplastic elastomer powder I having a particle size D₉₀ of about 146 μm.

### Example 7

100 parts by weight of TPU-2, 1.0 parts by weight of EBS, and 0.5 parts by weight of TD-1 were mixed by a high-speed mixer to obtain a mixture. The mixture was fed into a twin-screw extruder (25 ¢, L/D=48) for melt extrusion granulation to form composite particles, wherein the screw temperature may be 170° C. to 200° C. and the screw speed may be 150 rpm to 400 rpm. The composite particles were placed in liquid nitrogen for cryogenically grinding, and sieved to obtain a soft thermoplastic elastomer powder J having a particle size D₉₀ of about 250 μm.

### Example 8

Except that 1.0 part by weight of SnO₂ was also added, composite particles were formed in substantially the same manner as in Example 1. The composite particles were placed in liquid nitrogen and cryogenically ground into a soft thermoplastic elastomer powder K having a particle size D₉₀ of about 140 μm.

### Example 9

Except that 2 parts by weight of EBS was used, composite particles were formed in substantially the same manner as in Example 8. The composite particles were placed in liquid nitrogen and cryogenically ground into a soft thermoplastic elastomer powder L having a particle size D₉₀ of about 141 μm.

### Example 10

Except that 3 parts by weight of SnO₂ was used, composite particles were formed in substantially the same manner as in Example 8. The composite particles were placed in liquid nitrogen and cryogenically ground into a soft thermoplastic elastomer powder M having a particle size D₉₀ of about 149 μm.

### Example 11

Except that TD-3 was used instead of TD-1, composite particles were formed in substantially the same manner as in Example 1. The composite particles were placed in liquid nitrogen and cryogenically ground into a soft thermoplastic elastomer powder N having a particle size D₉₀ of about 147 μm.

### Example 12

Except that TPU-4 was used instead of TPU-2, composite particles were formed in substantially the same manner as in Example 1. The composite particles were placed in liquid nitrogen and cryogenically ground into a soft thermoplastic elastomer powder P having a particle size D₉₀ of about 142 μm.

### Example 13

Except that 2 parts by weight of EBS and 1.5 parts by weight of TD-1 were used, composite particles were formed in substantially the same manner as in Example 12. The composite particles were placed in liquid nitrogen and cryogenically ground into a soft thermoplastic elastomer powder Q having a particle size D₉₀ of about 148 μm.

### Example 14

Except that 1.0 part by weight of SnO₂ was also added, composite particles were formed in substantially the same manner as in Example 13. The composite particles were placed in liquid nitrogen and cryogenically ground into a soft thermoplastic elastomer powder R having a particle size D₉₀ of about 144 μm.

### Example 15

Except that 50 parts by weight of TPU-2 and 50 parts by weight of TPU-4 were used instead of 100 parts by weight of TPU-2, composite particles were formed in substantially the same manner as in Example 2. The composite particles were placed in liquid nitrogen and cryogenically ground into a soft thermoplastic elastomer powder S having a particle size D₉₀ of about 148 μm.

### Example 16

Except that 30 parts by weight of TPU-2 and 70 parts by weight of TPU-4 were used instead of 100 parts by weight of TPU-2, composite particles were formed in substantially the same manner as in Example 8. The composite particles were placed in liquid nitrogen and cryogenically ground into a soft thermoplastic elastomer powder T having a particle size D₉₀ of about 142 μm.

### Example 17

Except that 80 parts by weight of TPU-2 and 20 parts by weight of TPU-5 were used instead of 100 parts by weight of TPU-2, composite particles were formed in substantially the same manner as in Example 8. The composite particles were placed in liquid nitrogen and cryogenically ground into a soft thermoplastic elastomer powder V having a particle size D₉₀ of about 146 μm.

### Example 18

Except that 60 parts by weight of TPU-2 and 40 parts by weight of TPU-5 were used instead of 100 parts by weight of TPU-2, composite particles were formed in substantially the same manner as in Example 8. The composite particles were placed in liquid nitrogen and cryogenically ground into a soft thermoplastic elastomer powder W having a particle size D₉₀ of about 143 μm.

### Comparative Example 1

100 parts by weight of TPU-1 and 1.0 parts by weight of EBS were fed into a twin-screw extruder (25 ¢, L/D=48) for melt extrusion granulation to form composite particles, wherein the screw temperature may be 170° C. to 200° C. and the screw speed may be 150 rpm to 400 rpm. The composite particles were placed in liquid nitrogen and cryogenically ground into a soft thermoplastic elastomer powder A having a particle size D₉₀ of about 145 μm.

### Comparative Example 2

100 parts by weight of TPU-1, 1.0 parts by weight of EBS, and 0.5 parts by weight of TD-1 were fed into a twin-screw extruder (25 ¢, L/D=48) for melt extrusion granulation to form composite particles, wherein the screw temperature may be 170° C. to 200° C. and the screw speed may be 150 rpm to 400 rpm. The composite particles were placed in liquid nitrogen and cryogenically ground into a soft thermoplastic elastomer powder B having a particle size D₉₀ of about 144 μm.

### Comparative Example 3

100 parts by weight of TPU-1, 1.0 parts by weight of EBS, and 0.5 parts by weight of TD-2 were fed into a twin-screw extruder (25 ø, L/D=48) for melt extrusion granulation to form composite particles, wherein the screw temperature may be 170° C. to 200° C. and the screw speed may be 150 rpm to 400 rpm. The composite particles were placed in liquid nitrogen and cryogenically ground into a soft thermoplastic elastomer powder C having a particle size D₉₀ of about 146 μm.

### Comparative Example 4

100 parts by weight of TPU-3, 1.0 parts by weight of EBS, and 0.5 parts by weight of TD-1 were fed into a twin-screw extruder (25 ¢, L/D=48) for melt extrusion granulation to form composite particles, wherein the screw temperature may be 170° C. to 200° C. and the screw speed may be 150 rpm to 400 rpm. The composite particles were placed in liquid nitrogen and cryogenically ground into a soft thermoplastic elastomer powder O having a particle size D₉₀ of about 144 μm.

### Comparative Example 5

100 parts by weight of TPU-5, 1.0 parts by weight of EBS, and 0.5 parts by weight of TD-1 were mixed by a high-speed mixer to obtain a mixture. The mixture was fed into a twin-screw extruder (25° C., L/D-48) for melt extrusion granulation to form composite particles, wherein the screw temperature may be 170° C. to 200° C. and the screw speed may be 150 rpm to 400 rpm. The composite particles were placed in liquid nitrogen and cryogenically ground into a soft thermoplastic elastomer powder U having a particle size D₉₀ of about 145 μm.

The raw materials and ratio thereof contained in the soft thermoplastic elastomer powders A to W are shown in Tables 2 to 5 below. PBW in Tables 2 to 5 means parts by weight.

The particle sizes of the soft thermoplastic elastomer powders A to W were measured using a laser particle size analyzer (ISO 13320). The powder hardnesses of the soft thermoplastic elastomer powders A to W were measured using a Shore hardness tester (ASTM D₂₂₄). The process windows of the soft thermoplastic elastomer powders A to W were measured using a differential scanning calorimeter (ISO 11357). The conductivity coefficients of the soft thermoplastic elastomer powders A to W were measured using a thermal conductivity analyzer (ISO 22007-2). The melt viscosities of the soft thermoplastic elastomer powders A to W were measured using a capillary rheometer (ISO 11443).

While the soft thermoplastic elastomer powders A to W were dried, nano-silicon dioxides were added to the soft thermoplastic elastomer powders A to W to form compositions A to W, respectively. Compositions A to W were then placed in a selective laser sintering (SLS) printing device. The compositions A to W were spread into a layer having a thickness of about 150 μm by using an automatic powder spreading device for powder spreading. The powder bed temperature was raised to a fixed temperature according to different thermal properties, and laser sintering was performed at a laser power of 5 to 25 W and a scanning speed of 300 to 2000 mm/s to form tensile standard test samples A to W. Tensile strengths of the tensile standard test samples A to W were measured by a universal testing machine (ASTM D₆₃₈), and were defined as tensile strengths of the soft thermoplastic elastomer powders A to W. Elongations of the tensile standard test samples A to W were measured by a universal testing machine (ASTM D₆₃₈) and were defined as elongations of the soft thermoplastic elastomer powders A to W. The measured powder hardnesses, particle sizes, process windows, thermal conductivity coefficients, melt viscosities, tensile strengths and elongations of the soft thermoplastic elastomer powders A to W are listed in the following Tables 2 to 5.

TABLE 2

| | Comparative | Comparative | Comparative | Example | Example | Example | Example |
|---|---|---|---|---|---|---|---|
| | Example 1 | Example 2 | Example 3 | 1 | 2 | 3 | 4 |
| TPU-1 (PBW) | 100 | 100 | 100 | | | | |
| TPU-2 (PBW) | | | | 100 | 100 | 100 | 100 |
| EBS (PBW) | 1 | 1 | 1 | 1 | 1 | 2.5 | 1 |
| TD-1 (PBW) | | 0.5 | | 0.5 | 1.5 | 0.5 | 2.5 |
| TD-2 (PBW) | | | 0.5 | | | | |
| SnO₂ (PBW) | | | | | | | |
| Soft | A | B | C | D | E | F | G |
| thermoplastic | | | | | | | |
| elastomer | | | | | | | |
| powder No. | | | | | | | |
| Powder hardness | 40 | 40 | 40 | 41 | 42 | 41 | 42 |
| (Shore D) | | | | | | | |
| Particle size of the | 145 | 144 | 146 | 145 | 143 | 144 | 142 |
| powder (D₉₀, μm) | | | | | | | |
| Process window (° C.) | 10.4 | 15.5 | 11.7 | 32.1 | 30.8 | 26.4 | 24.1 |
| Thermal conductivity | 0.22 | 0.28 | 0.27 | 0.27 | 0.31 | 0.27 | 0.38 |
| coefficient (W/mK) | | | | | | | |
| Melt viscosity | 390 | 452 | 513 | 358 | 489 | 101 | 573 |
| (Tm + 30° C., Pa * s) | | | | | | | |
| Tensile strength | 43 | 48 | 29 | 108 | 120 | 67 | 52 |
| (kg/cm²) | | | | | | | |
| Elongation (%) | 125 | 220 | 137 | 287 | 340 | 185 | 223 |

TABLE 3

| | Example | Example | Example | Example | Example | Example | Example |
|---|---|---|---|---|---|---|---|
| | 5 | 6 | 7 | 8 | 9 | 10 | 11 |
| TPU-1 (PBW) | | | | | | | |
| TPU-2 (PBW) | 100 | 100 | 100 | 100 | 100 | 100 | 100 |
| EBS (PBW) | 1 | 2 | 1 | 1 | 2 | 1 | 1 |
| TD-1 (PBW) | | 1.5 | 0.5 | 0.5 | 0.5 | 0.5 | |
| TD-2 (PBW) | 1.5 | | | | | | |
| TD-3 (PBW) | | | | | | | 0.5 |
| SnO₂ (PBW) | | | | 1 | 1 | 3 | |
| Soft | H | I | J | K | L | M | N |
| thermoplastic | | | | | | | |
| elastomer | | | | | | | |
| powder No. | | | | | | | |
| Powder hardness | 41 | 41 | 41 | 42 | 41 | 41 | 41 |
| (Shore D) | | | | | | | |
| Particle size of the | 144 | 146 | 250 | 140 | 141 | 149 | 147 |
| powder (D₉₀, μm) | | | | | | | |
| Process window (° C.) | 18.5 | 30.8 | 32.1 | 29.5 | 28.5 | 22.1 | 29.5 |
| Thermal conductivity | 0.3 | 0.28 | 0.27 | 0.33 | 0.32 | 0.35 | 0.28 |
| coefficient (W/mK) | | | | | | | |
| Melt viscosity | 565 | 312 | 358 | 430 | 48 | 693 | 350 |
| (Tm + 30° C., Pa * s) | | | | | | | |
| Tensile strength | 63 | 123 | 72 | 130 | 95 | 77 | 102 |
| (kg/cm²) | | | | | | | |
| Elongation (%) | 194 | 375 | 205 | 380 | 275 | 198 | 333 |

TABLE 4

| | Comparative | | | |
|---|---|---|---|---|
| | Example 4 | Example 12 | Example 13 | Example 14 |
| TPU-3 (PBW) | 100 | | | |
| TPU-4 (PBW) | | 100 | 100 | 100 |
| EBS (PBW) | 1.0 | 1.0 | 2.0 | 2.0 |
| TD-1 (PBW) | 0.5 | 0.5 | 1.5 | 1.5 |
| TD-2 (PBW) | | | | |
| SnO₂ (PBW) | | | | 1 |
| Soft thermoplastic | O | P | Q | R |
| elastomer powder No. | | | | |
| Powder hardness (Shore D) | 21 | 28 | 27 | 27 |
| Particle size of the powder (D₉₀, μm) | 144 | 142 | 148 | 144 |
| Process window (° C.) | 5.4 | 25.0 | 26.4 | 27.3 |
| Thermal conductivity coefficient (W/mK) | 0.27 | 0.26 | 0.31 | 0.34 |
| Melt viscosity (Tm + 30° C., Pa*s) | 429 | 305 | 261 | 290 |
| Tensile strength (kg/cm²) | 24 | 88 | 94 | 101 |
| Elongation (%) | 192 | 350 | 402 | 345 |

TABLE 5

| | Example | Example | Comparative | Example | Example |
|---|---|---|---|---|---|
| | 15 | 16 | Example 5 | 17 | 18 |
| TPU-1 (PBW) | | | | | |
| TPU-2 (PBW) | 50 | 30 | | 80 | 60 |
| TPU-3 (PBW) | | | | | |
| TPU-4 (PBW) | 50 | 70 | | | |
| TPU-5 (PBW) | | | 100 | 20 | 40 |
| EBS (PBW) | 1.0 | 1.0 | 1.0 | 1.0 | 1.0 |
| TD-1 (PBW) | 1.5 | 0.5 | 0.5 | 0.5 | 0.5 |
| TD-2 (PBW) | | | | | |
| SnO₂ (PBW) | | 1 | | 1 | 1 |
| Soft thermoplastic | S | T | U | V | W |
| elastomer powder No. | | | | | |
| Powder hardness (Shore D) | 37 | 28 | 56 | 45 | 49 |
| Particle size of the powder (D₉₀, μm) | 148 | 142 | 145 | 146 | 143 |
| Process window (° C.) | 30.3 | 25.2 | 29.5 | 28.9 | 26.3 |
| Thermal conductivity coefficient (W/mK) | 0.31 | 0.32 | 0.28 | 0.31 | 0.30 |
| Melt viscosity (Tm + 30° C., Pa*s) | 405 | 419 | 623 | 560 | 628 |
| Tensile strength (kg/cm²) | 110 | 103 | 144 | 135 | 138 |
| Elongation (%) | 385 | 402 | 302 | 320 | 285 |

According to Tables 1 to 5 above, the soft thermoplastic elastomer powders D to G, I to N, and P to W all have the process windows of greater than 20° C., the Shore hardnesses of 20D to 49D, the thermal conductivity coefficients of 0.25 to 0.45 W/mK, and the melt viscosities of less than 1,000 Pa*s (0.63 rad/s) at a specific temperature (Tm+30° C.), which show that they are suitable for a selective laser sintering process and are soft materials. That is, the soft thermoplastic elastomer powder (i.e. the soft thermoplastic elastomer powder of the disclosure) made of the thermoplastic polyurethane elastomer having a process window ≥15° C., the thermal conductive agent having the thermal conductivity coefficient of 50 to 400 W/mK and the particle size of 0.5 μm to 6 μm, and the flow aid agent is suitable for the selective laser sintering process and is a soft material.

In addition, it can be seen from Tables 1 to 5, compared with the raw material TPU-2, the soft thermoplastic elastomer powder including TPU-2, a flow aid agent, a thermal conductive agent, and optional laser absorber has a larger process window, a larger thermal conductivity coefficient, and a lower melt viscosity. It is obvious that compared with using thermoplastic polyurethane elastomer powder alone, the soft thermoplastic elastomer powder prepared from the disclosure is more suitable for the selective laser sintering process.

It can further be seen from Tables 1 to 5 above that the tensile standard test samples D to N, P to T, V and W all have a tensile strength of more than 50 kg/cm² and an elongation of more than 185%. It is obvious that the soft thermoplastic elastomer powder of the present disclosure can be manufactured into a product having high elasticity by a selective laser sintering process.

In summary, the soft thermoplastic elastomer powder of the disclosure is suitable for a selective laser sintering process and can be used to produce dense, high-precision, and high-elasticity products.

Although embodiments of the present disclosure and the advantages thereof have been disclosed as described above, it should be understood that changes, substitutions and modifications may be made without departing from the spirit and scope of the disclosure. In addition, the protection scope of the present disclosure is not limited to the processes, machines, fabrications, compositions, devices, methods and steps in the specific embodiments described in the specification. According to the embodiments of the present disclosure, a person of ordinary skill in the art may understand that current or future processes, machines, fabrications, compositions, devices, methods and steps capable of performing substantially the same functions or achieving substantially the same results may be used in the embodiments of the present disclosure. Therefore, the protection scope of the present disclosure includes the above-mentioned processes, machines, fabrications, compositions, devices, methods and steps. In addition, features of different embodiments may be used together arbitrary as long as they do not violate the spirit of the disclosure or conflict with each other. Each claim constitutes an individual embodiment, and the protection scope of the present disclosure includes the combination of the claims and embodiments.

What is claimed is:

1. A soft thermoplastic elastomer powder, comprising:
100 parts by weight of a thermoplastic polyurethane elastomer, wherein a process window of the thermoplastic polyurethane elastomer is ≥15° C.;
0.01 to 2.0 parts by weight of a thermal conductive agent, wherein a thermal conductivity coefficient of the thermal conductive agent is 50 to 400 W/mK, and a particle size of the thermal conductive agent is 0.5 μm to 6 μm; and
0.05 to 2.0 parts by weight of a flow aid agent,
wherein the soft thermoplastic elastomer powder has a thermal conductivity coefficient of 0.25 to 0.45 W/mK, a Shore hardness of 20D to 49D, a process window of ≥20° C., and a melt viscosity of less than 1,000 Pas (0.63 rad/s) at a specific temperature (Tm+30° C.).

2. The soft thermoplastic elastomer powder as claimed in claim 1, further comprising up to 3.0 parts by weight of a laser absorber based on 100 parts by weight of the thermoplastic polyurethane elastomer.

3. The soft thermoplastic elastomer powder as claimed in claim 2, wherein the laser absorber is selected from a group consisting of carbon black, silicon carbide (SiC), tin oxide (SnO₂), iron oxide (Fe₂O₃), or a combination thereof.

4. The soft thermoplastic elastomer powder as claimed in claim 1, wherein a particle size of the thermal conductive agent is 0.5 μm to 5 μm.

5. The soft thermoplastic elastomer powder as claimed in claim 1, wherein the thermal conductive agent is selected from a group consisting of aluminum oxide (Al₂O₃), boron nitride (BN), aluminum nitride (AlN), graphene, or a combination thereof.

6. The soft thermoplastic elastomer powder as claimed in claim 1, wherein a particle size D₉₀ of the soft thermoplastic elastomer powder is ≤300 μm.

7. The soft thermoplastic elastomer powder as claimed in claim 6, wherein the particle size D₉₀ of the soft thermoplastic elastomer powder is 50 μm to 300 μm.

8. The soft thermoplastic elastomer powder as claimed in claim 1, wherein the melt viscosity of the soft thermoplastic elastomer powder is ≤700 Pa*s.

9. The soft thermoplastic elastomer powder as claimed in claim 1, wherein a melting point of the soft thermoplastic elastomer powder is ≤200° C.

10. The soft thermoplastic elastomer powder as claimed in claim 1, wherein the flow aid agent is selected from a group consisting of zinc stearate, N,N-Ethylene bis-stearamide (EBS), vinyltrimethoxysilane, oleamide, or a combination thereof.

11. A preparation method of a soft thermoplastic elastomer powder, comprising:
providing a mixture, wherein the mixture comprises a thermoplastic polyurethane elastomer, a flow aid agent and a thermal conductive agent;
performing a granulation process on the mixture to form composite particles; and
performing a grinding process on the composite particles to form the soft thermoplastic elastomer powder, wherein the mixture comprises:
100 parts by weight of a thermoplastic polyurethane elastomer;
0.01 to 2.0 parts by weight of a thermal conductive agent; and
0.05 to 2.0 parts by weight of a flow aid agent,
wherein the soft thermoplastic elastomer powder has a thermal conductivity coefficient of 0.25 to 0.45 W/mK, a melt viscosity of less than 1,000 Pa*s (0.63 rad/s) at a specific temperature (Tm+30° C.), a Shore hardness of 20D to 49D, and a process window of ≥20° C.

12. The preparation method of a soft thermoplastic elastomer powder as claimed in claim 11, wherein the mixture further comprises up to 3.0 parts by weight of a laser absorber.
